(19) United States
(12) Patent Application Publication
(10) Pub. No.: US 2017/0042371 A1
(43) Pub. Date: Feb. 16, 2017

(54) Foldable Food Grade Cooking Surface and Method of Use

(71) Applicant: Jack Lindon Skinner, Butte, MT (US)

(72) Inventor: Jack Lindon Skinner, Butte, MT (US)

(21) Appl. No.: 15/089,266

(22) Filed: Apr. 1, 2016

Related U.S. Application Data
(60) Provisional application No. 62/125,795, filed on Feb. 2, 2015.

(51) Int. Cl. A47J 36/04; A47J 29/00

(52) U.S. Cl. CPC A47J 36/04; A47J 29/00; A23L 1/0128; A23V 2002/00

(57) ABSTRACT

The described “Foldable Food Grade Cooking Surface and Method of Use” provides cooks of average skill the means to cook soft and fragile items, such as eggs, omelets, crepes, etc., without breaking such items while cooking. The Foldable Food Grade Cooking Surface is made of flexible, thermally conductive, mechanically stable, food grade material such as silicone with or without reinforcing fillers. The preferred embodiment includes handles for manipulating fragile food items during cooking and serving, without the need for traditional cooking implements. Non-planar surface topology, such as ridges, on the cooking surface of the Foldable Food Grade Cooking Surface contain cooking foods within predefined areas, such as the perimeter, of the cooking surface, and can act as a mold for foods that begin in a state that can flow (e.g. liquids of varying viscosity).

### CROSS REFERENCE TO RELATED APPLICATIONS

This application claims the benefit of Provisional Application No. 62/125,795 filed Feb. 2, 2015.

### BACKGROUND OF THE INVENTION

1. Field of the Invention

Herein described is a “Foldable Food Grade Cooking Surface and Method of Use,” which decreases the difficulty associated with cooking fragile items such as eggs, omelets, crepes, etc. The preferred embodiment is designed to be used on any traditional cook surface to easily cook fragile items without the need for difficult to use flipping utensils. The preferred embodiment is easily cleaned, and its foldable properties make storage very convenient.

2. Description of the Related Art (Problem/Solution by Others in Prior Art)

Soft and fragile food items are difficult for the average cook to make. Cooking items such as eggs, omelets, crepes, etc. requires above average cooking skill and dexterity to properly flip, fold, or manipulate such fragile foods. For example, omelets often turn into scrambles due to breaking the thin egg material during the folding step of cooking an omelet. Due to the difficulty of successfully cooking such foods, average cooks will likely avoid cooking foods that require such skills. There is currently no foldable food grade cooking surface, which would allow an average cook to successfully fold, flip, and manipulate soft and fragile foods while cooking.

Various flexible “baking sheets” are described in the prior art, which essentially provide a removable liner over traditional bakeware, to prevent baked foods from adhering to the bakeware. However, the functionality of such “baking sheets” is limited to baking applications, where the food item is placed on the sheet, and put into an oven for baking. No manipulation of the food item is generally required in such baking applications, until the item is fully cooked and ready for removal from the sheet. Furthermore, no handles or food containing ridges are present on such baking sheets, since their application requires use with a rigid baking sheet, and a completely flat surface to accept food items for baking.

Similarly, U.S. Pat. No. 7,850,035 (“035”) discloses a baking sheet consisting of a silicone surface with rods extending the length of the cooking surface and coupled to handles to form a semi-rigid baking sheet. The 035 invention is designed to be used in baking applications, and the invention's rods enable the sheet to be placed into and taken out of an oven without the use of a traditional baking sheet underneath. The 035 invention does not allow for any manipulation of food items during cooking due to the invention's rods creating a semi-rigid sheet. Similarly, the 035 invention does not have food containing ridges to contain liquid state foods during non-baking applications.

As such there is a need for a foldable food grade cooking surface, which can be used for all cooking applications, and allow easy manipulation of foods during cooking.

3. Objects of the Present Invention

Due to the limitations of the prior art in this field, there is a need for the present Foldable Food Grade Cooking Surface. The objectives of the present invention are to: (1) provide a foldable food grade cooking surface that works with a variety of cooking. applications; (2) provide a foldable food grade cooking surface with handles to allow for easy cooking, folding, and serving, of foods; (3) provide a foldable food grade cooking surface to allow easy manipulation of fragile foods such as eggs, omelets, crepes, etc.; (4) provide a cooking surface with food containing ridges, which contain foods on the cooking surface while in a liquid state; and (5) provide a foldable food grade cooking surface that is easily cleaned and stored due to its foldable properties.

### SUMMARY OF THE INVENTION

The subject invention solves the problems outlined above. The invention is made of a flexible food grade surface. The food grade surface material is thermally conductive and mechanically stable to a level suitable for repeated cooking cycles. An example material is food grade silicone, with or without fiber reinforcement. The preferred embodiment is composed of high temperature, FDA approved silicone with fiberglass reinforcement. The invention has handles and food containing ridges to easily allow for cooking and flipping of easily breakable food, such as (but not limited to) omelets, eggs, crepes, etc. Said handles extend over the perimeter of the heated cook top being used so that the cook can easily grasp them to manipulate the food, and remove the foldable food grade cooking surface from the heat source once cooking is complete. The invention allows liquid, such as liquid egg mixture, to be contained on a flat and foldable surface, so the cook can fold and manipulate the invention with little skill. The food containing ridges also help contain the cooking food to reduce clean-up of the cooking surface (skillet, oven, grill, etc.).

The subject invention is used by placing the invention on a heated cooktop such as an electric skillet, griddle, grill, or frying pan. In the case of cooking an omelet, egg mixture is poured on top of the invention, within the boundaries of the food-containing-ridges. The food containing ridges are made of the same material comprising the foldable food grade cooking surface. Said ridges can be formed along the perimeter of the food grade cooking surface, or can be formed in specific shapes to act as a mold for precise cooking of food items. For example, the food containing ridge could form a circle, which would allow the cook to create a perfectly circular omelet. Omelet fillings such as cheese, meat, and vegetables can then be sprinkled on top of the cooking omelet mix. When the omelet mix has cooked to the point where flipping is required, the cook grasps the invention's left handle and lifts up and over to the right, such that the omelet folds back over itself, roughly ⅔ of the way to the right edge of the omelet. The left handle is then placed back in its original position on the left side of the heated cooktop. The cook then grasps the right handle, and lifts up and over to the left, such that the right side of the omelet folds over and on top of the rest of the previously folded omelet. This completes the omelet. The cook then grasps both left and right handles simultaneously, and lifts the Foldable Food Grade Cooking Surface off the cooktop. The omelet can be served by gently tipping the surface towards a plate, in order to slide the omelet onto the plate. No special utensils such as spatulas are necessary. Once cleaned, the Foldable Food Grade Cooking Surface can be rolled, folded or slid into almost any storage space.

### BRIEF DESCRIPTION OF THE DRAWINGS

FIG. 1—Perspective view of Foldable Food Grade Cooking Surface on flat surface.

FIG. 2—Exploded view of Foldable Food Grade Cooking Surface depicting raised food containing ridges.

FIG. 3—Perspective view of Foldable Food Grade Cooking Surface in use on electric cook top.

FIG. 4—Perspective view of egg mixture being poured for cooking onto Foldable Food Grade Cooking Surface, contained within food containing ridges.

FIG. 5—Perspective view of omelet being folded by manipulation of Foldable Food Grade Cooking Surface handles.

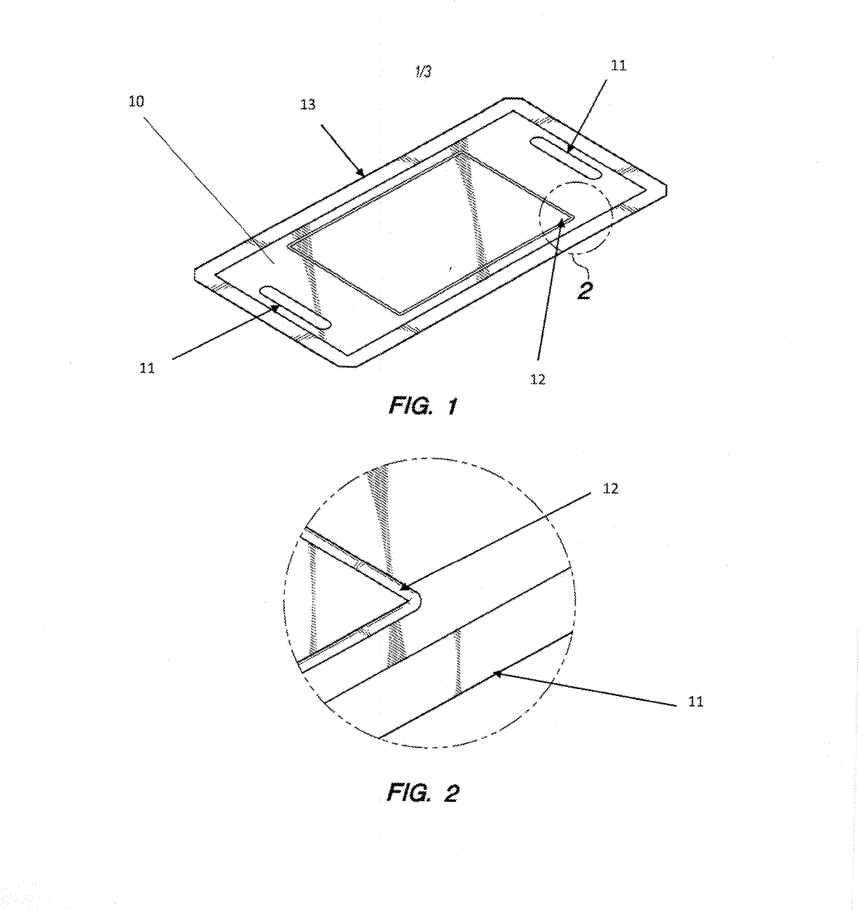

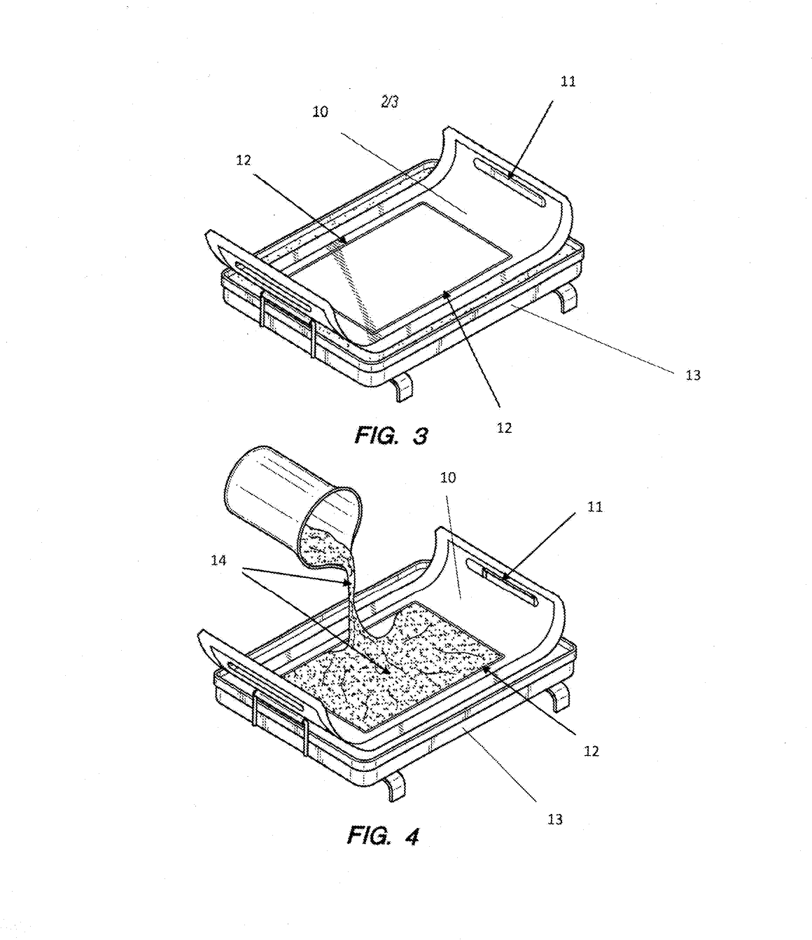

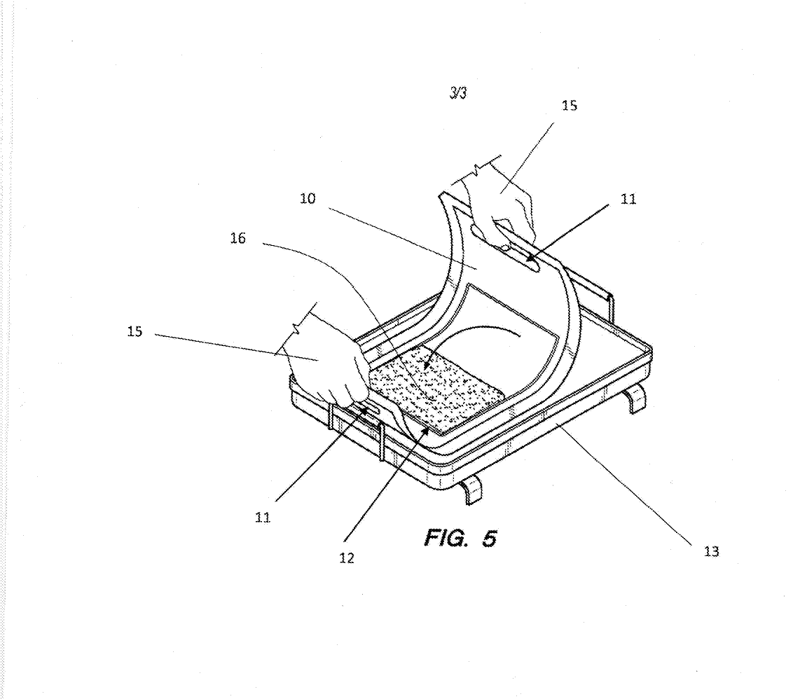

### REFERENCE NUMBERS

### 10 Foldable Food Grade Cooking Surface

### 11 Handle

12 Food containing ridge
13 Electric cook top
14 Liquid egg mixture
15 Cook manipulating handles
16 Folded omelet

### DETAILED DESCRIPTION OF THE PREFERRED EMBODIMENTS

Although only one embodiment is explained in detail, the figures and specifications should be understood as illustrations only, and are not intended to limit the invention in its scope. Also, in describing the embodiment specific terminology may be used, but it should be understood that specific terms include all technical equivalents that operate in similar manners to accomplish similar purposes.

The Foldable Food Grade Cooking Surface 10 is comprised of high temperature, FDA approved silicone with fiberglass reinforcement. The invention has handles 11 and food containing ridges 12 to easily allow for cooking and flipping of easily breakable food, such as omelets, eggs, crepes, etc. Said handles 11 extend over the perimeter of the heated cook top 13 being used so that the cook 15 can easily grasp them to manipulate the food 16, and remove the Foldable Food Grade Cooking Surface 10 from the heat source 13 once cooking is complete. The invention allows liquid, such as liquid egg mixture 14, to be contained on a flat and foldable surface, so the cook 15 can fold and manipulate the invention with little skill. The food containing ridges 12 also help contain the cooking food to reduce clean-up of the cooking surface 13.

The subject invention 10 is used by placing the invention on a heated cooktop 13. In the case of cooking an omelet 16, egg mixture 14 is poured on top of the invention 10, within the boundaries of the food-containing-ridges 12. The food containing ridges 12 are made of the same material comprising the foldable food grade cooking surface 10. Said ridges 12 can be formed along the perimeter of the food grade cooking surface 10, or can be formed in specific shapes to act as a mold for precise cooking of food items. For example, the food containing ridge 12 could form a circle, which would allow the cook to create a perfectly circular omelet. Omelet fillings such as cheese, meat, and vegetables can then be sprinkled on top of the cooking omelet mix 14. When the omelet mix 14 has cooked to the point where flipping is required, the cook grasps the invention's left handle 11 and lifts up and over to the right, such that the omelet 16 folds back over itself, roughly ⅔ the way to the right edge of the omelet. The left handle 11 is then placed back in its original position on the left side of the heated cooktop 13. The cook 15 then grasps the right handle 11, and lifts up and over to the left, such that the right side of the omelet folds over and on top of the rest of the previously folded omelet. This completes the omelet 16. The cook 15 then grasps both left and right handles 11 simultaneously, and lifts the Foldable Food Grade Cooking Surface 10 off the cooktop 13 for serving of the cooked omelet, or other food item.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

I claim:

1. A foldable food grade cooking surface comprising;
(a) a flexible, thermally conductive, and mechanically-stable food-grade cooking surface.

2. The foldable food grade cooking surface of claim 1, further comprised of reinforcing fiberglass cloth filler.

3. The foldable food grade cooking surface of claim 1, further comprising handles for grasping and manipulation.

4. The foldable food grade cooking surface of claim 1, further comprising food containing ridges on the cooking surface of said foldable food grade cooking surface.

5. A foldable food grade cooking surface comprising;
(a) a flexible, thermally conductive, and mechanically stable food grade cooking surface;
(b) handles for grasping and manipulation;
(c) food containing ridges on the cooking surface of said foldable food grade cooking surface; and
(d) reinforced fiberglass cloth filler.

6. The foldable food grade cooking surface of claim 5, where said foldable food grade cooking surface is rectangular in shape.

7. The foldable food grade cooking surface of claim 5. where said foldable food grade cooking surface is rectangular in shape and said handles are located at the longitudinal ends of said foldable food grade cooking surface.

8. The foldable food grade cooking surface of claim 5, where said foldable food grade cooking surface is rectangular in shape, and said handles are located at the longitudinal ends of said foldable food grade cooking surface, and said handles are comprised of the same material as said foldable food erode cooking surface.

9. The foldable food grade cooking surface of claim 5, where said foldable food grade cooking surface is rectangular in shape, and said handles are located at the longitudinal ends of said foldable food grade cooking surface, and said handles are comprised of the same material as said foldable food grade cooking surface, and the length of said foldable food grade cooking surface allows said handles to extend over the perimeter of the heated cook top surface.

10. The foldable food grade cooking surface of claim 5 where said food containing ridges are comprised of the same material as said foldable food grade cooking surface.

11. The foldable food grade cooking surface of claim 5 where said food containing ridges are comprised of the same material as said foldable food grade cooking surface, and located on the perimeter of said foldable food grade cooking surface.

12. The foldable food grade cooking surface of claim 5 where said food containing ridges are comprised of the same material as said foldable food grade cooking surface, and located within the perimeter of said foldable food grade cooking surface.

13. The foldable food grade cooking surface of claim 5 where said food containing ridges are comprised of the same material as said foldable food grade cooking surface, and located within the perimeter of said foldable food grade cooking surface, and said food containing ridges comprise a specific shape to mold food cooked within said food containing ridges.

14. A foldable food grade cooking surface comprising:
(a) a flexible, thermally conductive, and mechanically stable food grade cooking surface;
(b) handles for grasping and manipulation; and
(c) food containing ridges on the cooking surface of said foldable food grade cooking surface;
(d) reinforced fiberglass cloth filler;
(e) where said foldable food grade cooking surface is rectangular in shape;
(f) said handles are located at the longitudinal ends of said rectangular shaped foldable food grade cooking surface;
(g) where said handles are comprised of the same material as said foldable food grade cooking surface;
(h) where the length of said foldable food grade cooking surface allows said handles to extend over the perimeter of the heated cook top surface;
(i) where said food containing ridges are comprised of the same material as said foldable food grade cooking surface; and
(j) where said food containing ridges are located on the perimeter of said foldable food grade cooking surface.

15. A foldable food grade cooking surface comprising:
(a) a flexible, thermally conductive, and mechanically stable food grade cooking surface;
(b) handles for grasping and manipulation; and
(c) food containing ridges on the cooking surface of said foldable food grade cooking surface;
(d) reinforced fiberglass cloth filler;
(e) where said foldable food grade cooking surface is rectangular in shape;
(f) said handles are located at the longitudinal ends of said rectangular shaped foldable food grade cooking surface;
(g) where said handles are comprised of the same material as said foldable food grade cooking surface;
(h) where the length of said foldable food grade cooking surface allows said handles to extend over the perimeter of the heated cook top surface;
(i) where said food containing ridges are comprised of the same material as said foldable food grade cooking surface; and
(j) said food containing ridges are located within the perimeter of said foldable food grade cooking surface.

16. The foldable food grade cooking surface of claim 15, where said food containing ridges comprise a specific shape to mold food cooked within said food containing ridges.

17. A method for using a foldable food grade cooking surface comprising the steps of:
(a) placing a foldable food grade cooking surface on a heated cook top surface;
(b) positioning food to be cooked within the food containing ridges of said foldable food grade cooking surface;
(c) folding or flipping said food by manipulating the handles of said foldable food grade cooking surface; and
(d) serving said food by simultaneously lifting said handles and tipping said foldable food grade cooking surface toward a plate until said food slides onto said plate.
